(19) United States
(12) Patent Application Publication
(10) Pub. No.: US 2008/0237145 A1
(43) Pub. Date: Oct. 2, 2008

(54) Method and Apparatus for the Photocatalytic Treatment of Fluids

(76) Inventors: Bruce Jefferson, Bedford (GB); Simon Parsons, Northampton (GB)

Correspondence Address: The Weintraub Group, 32000 Northwestern Highway, Suite 240, Farmington Hills, MI, 48334, US

(21) Appl. No.: 11/883,252

(22) PCT Filed: Jan. 27, 2006
(86) PCT No.: PCT/GB2006/000301

§ 371 Date: Apr. 28, 2008

(30) Foreign Application Priority Data
Jan. 27, 2005 (GB) 05016886.6

(51) Int. Cl. B01D 24/46; C02F 1/32; B01J 8/02

(52) U.S. Cl. 210/748; 210/797; 422/211

(57) ABSTRACT

A treatment system comprises a reactor vessel (2) wherein an aqueous solution is chemically treated using titanium dioxide catalytic particles in the solution, a membrane device (18) including tubular filtering membranes in communication with the vessel 2 for separating the particles from the solution by detaining the particles on entry-surfaces of the membranes, and a sparging device which causes injected air to flow over the entry surfaces to discourage clogging of the membranes by the particles. The reactor vessel (2) contains UV tubes (3) and the membrane device includes a coarse bubble aeration delivery device for producing slug pattern flow of the air over the entry surfaces of the membranes.

This invention is concerned with a system for the batch or continuous chemical treatment of a fluid, in particular but not limitatively treatment of water containing organic and/or inorganic compounds by a photocatalytic process coupled with a membrane.

The ability to degrade organic and inorganic compounds in liquid effluents utilising UV irradiation and TiO₂ as a photocatalyst is well documented. The UV light provides the energy required to produce electron holes and hydroxyl radicals (.OH) at the surface of the photocatalyst. These charge carriers then perform reduction/oxidation (redox) reactions with chemical contaminants, with the ultimate degraded products being the oxides of the contaminant elemental components. Suspended TiO₂ systems provide faster degradation of contaminant species in comparison with immobilised TiO₂ systems, as suspended systems can provide a greater catalyst surface area for redox reactions to occur. Detailed work on the design of these suspended solid photocatalytic reactors has been undertaken and much is known with regard to optimising their performance.

After treatment the photocatalyst is removed from the liquid containing the degraded contaminants, for recycling of the catalyst. Previous work has shown that ultrafiltration and microfiltration membranes are suitable for this removal.

Although the mean primary particle size of TiO₂ in suspension is quoted by suppliers of the TiO₂ particles as 10-30 nm, suggesting membranes with ultrafiltrate pore sizes, in aqueous media the TiO₂ particles form aggregates within the micron range, so that ultrafiltration (UF) membranes would appear to be unsuitable in those circumstances. Moreover, the use of ultrafiltration membranes implies higher operating pressures and thus higher energy input compared to microfiltration (MF) membranes. In addition, there is the possibility of contaminant gel layer formation at a membrane/wastewater stream interface causing a reduction in throughput and increased requirement for cleaning. So, in terms of the development of a commercially viable process, microfiltration membranes are more desirable.

There are no universally accepted definitions of microfiltation (MF) and ultrafiltration (UF), but, for present purposes, they could be assumed to be that pore sizes for MF range from roughly 10⁻⁶ metres to roughly 10⁻⁷ metres and that UF pore sizes range from roughly 10⁻⁷ metres to approaching 10⁻⁹ metres.

Moreover, circulation of the TiO₂-containing effluent over the entry surface of the membrane is required in order to reduce fouling due to the build-up of a TiO₂ cake layer at the entry surface. The latter circulation can be provided by a pump but the abrasive nature of TiO₂ requires careful pump selection.

According to one aspect of the present invention, there is provided a method comprising chemically treating a fluid using catalytic particles in said fluid, separating said particles from said fluid at a filtering membrane through which said fluid but not said particles pass, and discouraging clogging of said membrane by said particles by causing a gaseous medium to flow over the entry surface of said membrane.

According to another aspect of the present invention, there is provided apparatus comprising a reactor wherein a fluid is chemically treated using catalytic particles in said fluid, a filtering membrane in fluid flow communication with said reactor and for separating said particles from said fluid by detaining said particles on an entry surface of said membrane, and a device which causes gaseous medium to flow over said entry surface to discourage clogging of said membrane by said particles.

Owing to these aspects of the invention, it is possible to improve the commercial viability of the separation step.

The present invention is particularly applicable in situations in which the fluid is a liquid, although it is not inconceivable that it is applicable also to a gaseous substance. The operation of the system varies depending upon the fluid being treated.

A preferred embodiment of this invention provides an improved system for the continuous treatment of aqueous solutions containing recalcitrant organic and/or inorganic compounds by combining a suspended photocatalytic chemical reactor with a membrane for separating the photocatalyst, in particular TiO₂, from the aqueous solution.

A system for such treatment comprises a chemical reactor vessel containing one or more UV tubes, TiO₂ suspension, a coarse bubble aeration delivery device, an externally mounted membrane device for the separation of TiO₂ from the solution and production of a decontaminated effluent stream. Liquid effluent is fed to the vessel (after initial treatment to remove large suspended material, the type of initial treatment being dependent on the characteristics of the effluent).

Circulation of the TiO₂-containing effluent in the reaction vessel maintains the TiO₂ in suspension and ensures optimum mass transfer. In addition circulation of the TiO₂-containing effluent through the interior(s) of one or more tubular membranes of the externally placed, vertically orientated, membrane device maintains flow over the inner, i.e. entry, surface(s) of the membrane(s). This is provided by injecting air to flow across the entry surface(s) of the membrane(s). If desired, air may be injected to provide mixing within the reactor vessel. In the case of the reactor, air may be supplied via a distribution ring housed near the bottom of the vessel with a series of holes formed in the ring in order to provide a relatively even distribution of air to the reactor. In the case of the membrane(s), air may be injected into the lumen(s) of the membrane(s) via an intersection connecting the reactor to a housing of the membrane device. Introduction of air at this point generates an airlift effect whereby liquid will be displaced up through the membrane lumen(s) by the movement of air bubbles. The air will be supplied by a coarse bubble device such that the gas bubbles travel up through the lumen(s) in a slug flow pattern; that is to say, each gas bubble fills the entire width of the lumen. Liquid passes back into the reactor through a second inlet which extends from the top of the membrane housing and which is situated slightly above the height of the liquid in the reactor vessel.

The membrane device is configured as an external, vertically mounted airlift device. The membrane(s) comprise(s) either a ceramic or a polymeric tubular membrane module of sufficient size to enable the circulating flow to pass longitudinally up through the lumen(s) of the membrane device. The membrane pore size is set appropriately to the size of the TiO₂ particles but is expected to be in the MF/UF range. A gas sparger is located in a housing below the membrane device to provide an air-sparged liquid stock (i.e. a mixture of the air, the TiO₂ and the effluent) at the bottom end of the device to give airlift circulation of the stock from the reactor through the device. The device separates the stock into a filtrate and a residual, gas-containing retentate that passes from the top end of the device back into the reactor. The transmembrane pressure driving force can be applied by using a filtrate pump to generate a pressure in the filtrate line below that of the liquid in the lumen(s). Alternatively, the filtrate can be withdrawn through a valve which regulates the flow through the filtrate line. In such circumstances the driving pressure is generated by an hydraulic head between the water level in the reactor and the filtrate outlet from the membrane device.

Instead of the membranes being tubular, they may be planar and parallel to each other, with the coarse, air lift bubbles ascending in the gaps among the membranes. Whilst it is envisaged that the reactor will be vented and so at atmospheric pressure, a pressurised feed system can also be utilised whereby the liquid flow is circulated around the membrane device by means of a pump, the pump acting in combination with the air lift.

Effluent is fed to the top of the reactor to maximise initial exposure to UV light and thereby ensure degradation of the contaminants. The pressurised air is supplied at a rate and pressure sufficient to ensure complete mixing of the TiO₂ suspension and to provide the required scouring of the membrane(s).

Means (not shown) for enabling removal and addition of TiO₂ slurry suspension is also provided, as some effluent stream contaminants foul the surfaces of the TiO₂ particles, whereby the activity of the TiO₂ is reduced. Thus there may be some requirement to replace the TiO₂ once the activity has decreased below an acceptable value.

The term “contaminated waste stream” as used herein describes a liquid containing undesirable compounds, whether inorganics, or whether organics, for example microbial or biological matter.

The term “undesirable” does not necessarily imply that the compounds are toxic. The term “decontaminated waste stream” as used herein describes the waste stream when the contaminants have been degraded or altered to desirable or acceptable substances.

The catalyst that is preferably employed with the system of the current invention is anatase TiO₂.

In order that the invention may be clearly and completely disclosed, reference will now be made, by way of example, to the accompanying drawings, in which:

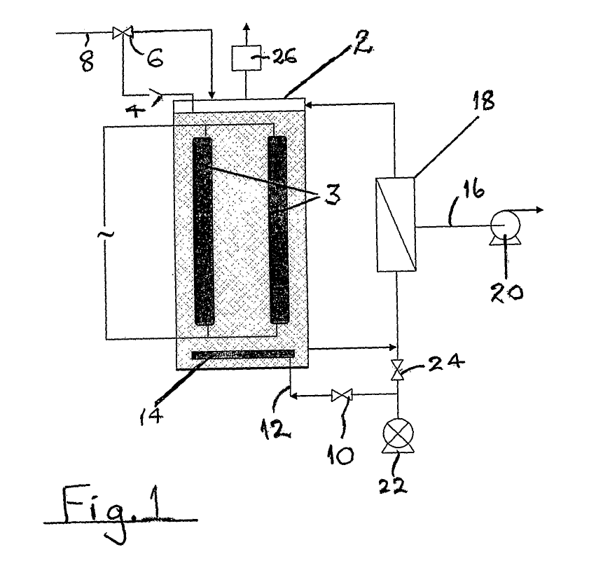

FIG. 1 is a diagram of a system for chemical treatment of water;

FIG. 2 shows a graph illustrating fouling of filtering membranes of a membrane device of the system for various levels of treatment of the NOM-containing water;

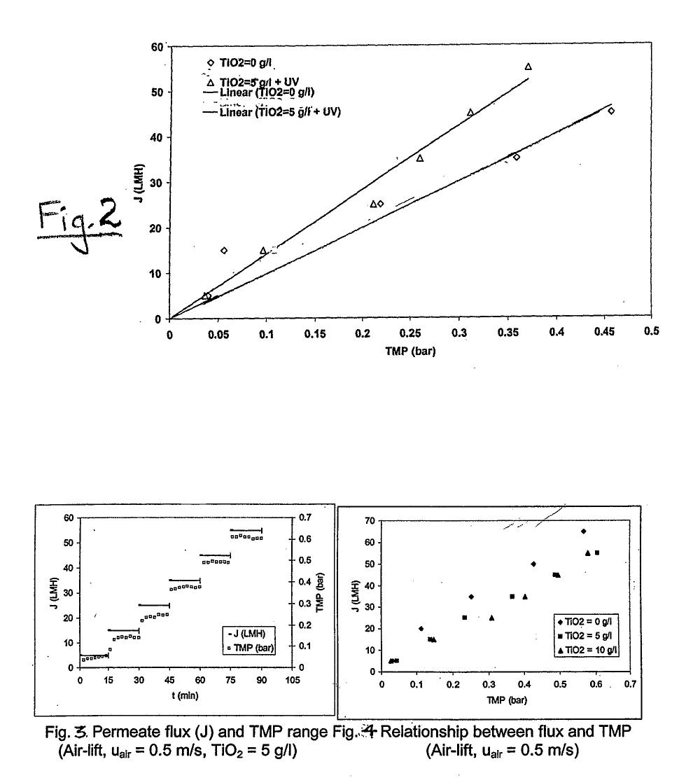

FIG. 3 shows a graph illustrating fouling of the filtering membranes of the membrane device of the system for various levels of flux through the membranes for grey water;

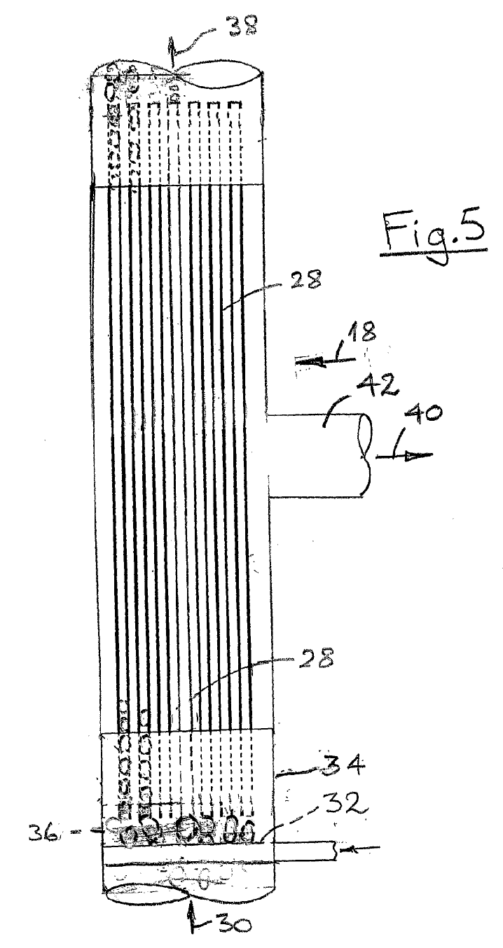

FIG. 4 shows a graph illustrating fouling of the filtering membranes of the membrane device for various levels of treatment of the grey water; and

FIG. 5 is a diagrammatic elevation of a membrane device of the system.

Referring to FIG. 1, a process flow diagram of a continuous purification system in accordance with a preferred embodiment of the present invention is illustrated. A slurry, which contains a photoreactive catalyst (in this case TiO₂ particles), entrained air and contaminated aqueous effluent is contained within a chemical reactor vessel 2 containing UV-C tubes 3. The ingress of contaminated effluent is controlled by a level controller 4 which actuates a valve 6 in a line 8 from a feed tank (not shown). Air flow to the reactor vessel 2 is controlled by a valve 10 in a compressed air supply line 12 to a sparger 14 and is set such that the TiO₂ particles remain in suspension. Outflow of the decontaminated effluent is controlled by the combination of the head of water in the reactor vessel 2 above the height of a filtrate line 16 out of a membrane device 18 and suction pressure generated by a filtrate pump 20 in the line 16. Air supplied to the membrane device 18 is controlled by an air pump 22, which may be in the form of a compressor, and a valve 24 and set to produce sufficient flow through lumens of the membranes to restrict fouling. The membranes of the device 18 shown diagrammatically in FIG. 1 are of tubular form and extend from upper to lower plates of the device 18 which prevent flow of stock from the reactor vessel 2 to the volume among the membranes except through the membranes themselves, so that TiO₂ particles are detained at the inner peripheral, tubular entry surfaces of the membranes and the purified water flows through the membranes into that volume and is then led away as a filtrate via the line 16. The reactor vessel 2 is vented to the atmosphere via a filter unit 26 to prevent escape of volatile organic material from the reactor vessel 2. Any gas in the decontaminated liquid stream fed to the reactor vessel 2 via the membranes will also exit the reactor vessel 2 via the filter unit 26.

As illustrated in FIG. 5, the membrane device 18 is configured as a vertical airlift device. The membranes 28 comprise either ceramic or polymeric tubular membranes of sufficient total throughflow cross-sectional area to enable the circulating flow of aqueous solution entering as indicated at 30 to pass longitudinally up through the lumens of the membrane device 18. The membrane pore size is set appropriately to the size of the TiO₂ particles but is expected to be in the MF/UF range. A gas sparger 32 is located in a lower housing 34 of the membrane device to provide an air-sparged liquid stock 36 (i.e. a mixture of the air, the TiO₂ and the effluent) at the bottom end of the device 18 to give airlift circulation of the stock 36 from the reactor vessel 2 through the device. The device 18 separates the stock 36 into a filtrate which exits into a filtrate line, as indicated at 40, and a residual, gas-containing retentate that passes from the top end of the device 18, as indicated at 38, back into the reactor vessel 2. The transmembrane pressure driving force can be applied by using a filtrate pump (not shown) to generate a pressure in the filtrate line below that of the liquid in the lumens.

Alternatively, the filtrate can be withdrawn through a valve (not shown) which regulates the flow through the filtrate line. In such circumstances the driving pressure is generated by an hydraulic head between the water level in the reactor vessel 2 and the filtrate outlet 42 from the membrane device 18.

In order to ascertain how well the preferred embodiment described with reference to FIG. 1 performed, testing was carried out upon two treatment examples, namely NOM-containing water and grey water.

### EXAMPLE I

NOM-Containing Water

Water sources throughout the World contain NOM as a result of the interactions between the hydrological cycle and the biosphere and geosphere. NOM is a complex mixture of organic material and has been shown to consist of organics as diverse as humic acids, hydrophilic acids, proteins, lipids, hydrocarbons and amino acids. The range of organic components in NOM varies from water to water and seasonally; this consequently leads to variations in the reactivity of NOM with chemical disinfectants such as chlorine. As legislation governing drinking water quality becomes ever more stringent water treatment works (WTW) using conventional treatment processes, such as coagulation, are unable to meet the removal targets required to meet trihalomethanes (THM) and haloacetic acid (HAA) standards. Many treatment processes have been investigated for removing THM and HAA precursors but have the problem of reaching significantly low residual dissolved organic carbon (DOC) levels without generating significant quantities of sludge. The application of advanced oxidation processes (AOPs) for treating NOM or humic acids has been researched by several authors who all found the TiO₂ photocatalysis to be effective at treating humics. The system described with reference to FIG. 1 has been evaluated as to its degree of removal of THM and HAA precursors from a model humic water and water samples from Ewden Reservoir, Sheffield, United Kingdom. UV₂₅₄ was used as a surrogate for THM and HAA measurements in these experiments and the results showed the effectiveness of the process in removing THM and HAA precursors, since at 5 g/L suspension virtually 98% of the UV₂₅₄ was removed with 5 g/l of TiO₂ plus UV. In FIG. 2, Flux (J) is plotted against transmembrane pressure (TMP) for zero TiO₂ and for TiO₂=5 g/l plus UV, both as point test result graphs and as linear graphs. FIG. 2 demonstrates that the critical flux (J) of a membrane is above 50 L.m⁻².h⁻¹ (known as “LMH”), that is to say that no rapid fouling took place when the experimental plant was operated at fluxes (J) up to that specific limit. Furthermore, operation below the stated critical value provides a probable condition for prolonged operation without the need for cleaning of the membranes.

### EXAMPLE II

Grey Water

Grey water arises from domestic washing operations; its sources include waste from handbasins, kitchen sinks and washing machines. Grey water is usually generated by the use of soap or soap products for body washing and, as such, varies in quality according to, amongst other things, geographical location, demographics and level of occupancy. Although the concentration of organics is similar to domestic wastewater their chemical nature is quite different. The relatively low value for biodegradable organic matter and the nutrient imbalance limit the effectiveness of biological treatment of grey water. Many treatment schemes proposed use mainly physical and biological processes and have problems adjusting to the shock loading of organic matter and/or chemicals.

FIG. 3 shows that, in the very short term, it is possible, with the system described with reference to FIG. 1, to work in a range of permeate fluxes between 5 LMH and 55 LMH with no clear signs of membrane fouling working up to fluxes of 60 LMH. This result is likely to reflect the long-term situation. Uₐᵢᵣ is the velocity of the air travelling up through the lumens of the tubular membranes. FIG. 4 shows the membrane permeability values when using grey water with different TiO₂ concentrations which are in the range used in the AOP. Performance data is shown in Table 1 and shows how effective the system described with reference to FIG. 1 is in reducing DOC, turbidity and biological oxygen demand (BOD).

TABLE 1

| | | | COD (mg/L) | | | | Turbidity (NTU) | | | | BOD (mg/L) | | | |
|---|---|---|---|---|---|---|---|---|---|---|---|---|---|---|
| NAME | uair (m/s) | TiO2 (g/l) | Raw | P1 | P2 | P3 | Raw | P1 | P2 | P3 | Raw | P1 | P2 | P3 |
| Exp 38 | 0.5 | 0 | 368 | 74 | 124 | 128 | 28.1 | 4.2 | 1.54 | 2.32 | 128 | 7 | 28 | 22 |
| Exp 48 | 0.5 | 0 | | | | | | | | | | | | |
| Exp 39 | 1.25 | 0 | 206 | 92 | 102 | 106 | 17.2 | 1.33 | 0.44 | 1.56 | 78 | 12 | 19 | 21 |
| Exp 42 | 0.5 | 5 | 244 | 78 | 90 | 76 | 15.3 | 1.56 | 2.21 | 3.55 | 68 | 16 | 14 | 9 |
| Exp 43 | 1.25 | 5 | 284 | 66 | 108 | 104 | 28.8 | 2.61 | 5.07 | 0.24 | 105 | 16 | 26 | 23 |
| Exp 44 | 0.5 | 10 | 206 | 60 | 72 | 70 | 16.4 | 2.34 | 49.5 | 26.1 | 63 | 15 | 15 | 14 |
| Exp 45 | 1.25 | 10 | 240 | 80 | 80 | 62 | 33.6 | 21.6 | 77.7 | 118 | 68 | 12 | 15 | 15 |
| Exp 49 | 0.5 | 5 + UV | 324 | 72 | 98 | 98 | 18.7 | 0.64 | 1.39 | 0.63 | 135 | 17 | 17 | 14 |
| Exp 50 | 1.25 | 5 + UV | 324 | 56 | 86 | 84 | 18.7 | 1.1 | 2.66 | 0.35 | 135 | 5 | 9 | 9 |
| Exp 51 | 0.5 | 10 + UV | 290 | 68 | 76 | 76 | 15.6 | 1.35 | 0.87 | 3.57 | 114 | 2 | 4 | 2 |
| Exp 52 | 1.25 | 10 + UV | 252 | 68 | 84 | 56 | 16.9 | 1.67 | 0.61 | 1.77 | 128 | 5 | 8 | 10 |

N.B. “Exp.” gives the experiment number.
“Raw” means raw grey water supplied to the reactor vessel.
“P1” to “P3” mean three samples taken of the filtrate.

It will thus be understood that it is possible to obtain improved results for treatment of NOM-containing water and grey water, particularly as regards removal of TMH and HAA precursors from NOM-containing water and removing organics from grey water. The treatment of the water advantageously involves the combination of UV-C and TiO₂ particles.

We claim:

1-11. (canceled)

12. A method comprising chemically treating a fluid using catalytic particles in said fluid, separating said particles from said fluid at a filtering membrane through which said fluid but not said particles pass, and discouraging clogging of said membrane by said particles discouraging clogging of said membrane by said particles by causing a gaseous medium to flow over the entry surface of said membrane.

13. A method according to claim 12, wherein said fluid comprises water containing natural organic matter.

14. A method according to claim 12, wherein said fluid comprises grey water.

15. A method according to claim 12, wherein said fluid comprises an aqueous solutions containing recalcitrant organic and/or inorganic compounds.

16. A method according to claim 12, wherein said particles are photocatalytic, said method further comprising exposing said particles to radiation to initiate a catalytic action.

17. A method according to claim 16, wherein said particles are titanium dioxide and said radiation is ultraviolet.

18. A method according to claim 12, wherein said gaseous medium rises in a slug flow pattern over said entry surface.

19. Apparatus comprising a reactor vessel wherein a fluid is chemically treated using catalytic particles in said fluid, one or more filtering membranes in fluid flow communication with said reactor vessel and for separating said particles from said fluid by detaining said particles on an entry surface of the or each membrane, and a device which causes gaseous medium to flow over the entry surface(s) to discourage clogging of the membrane(s) by said particles.

20. Apparatus according to claim 19, wherein said device comprises a coarse bubble aeration delivery device serving to produce slug pattern flow of said gaseous medium over said entry surface(s).

21. Apparatus according to claim 19, wherein said reactor vessel has one or more sources of ultraviolet radiation and said catalytic particles comprise titanium dioxide.

22. Apparatus according to claim 19, wherein the or each membrane is a tubular membrane.
